(19) United States
(12) Patent Application Publication
(10) Pub. No.: US 2018/0268042 A1
(43) Pub. Date: Sep. 20, 2018

(54) ENTITY-BASED DYNAMIC DATABASE LOCKDOWN

(71) Applicant: Linkedln Corporation, Sunnyvale, CA (US)

(72) Inventors: Hailin Wu, Sunnyvale, CA (US); Xiao Bao, Mountain View, CA (US); Rongsheng Liang, Cupertino, CA (US); Jianhong Fang, Milpitas, CA (US); Qi Liu, Saratoga, CA (US); Hao Ji Wu, San Francisco, CA (US); Fan Gao, Sunnyvale, CA (US); Florence Zhang, Sunnyvale, CA (US); Dakan Wang, Mountain View, CA (US)

(21) Appl. No.: 15/461,105

(22) Filed: Mar. 16, 2017

(51) Int. Cl. G06F 17/30

(52) U.S. Cl. CPC G06F 17/30575; G06F 17/30424; G06F 17/30362

(57) ABSTRACT

A machine may be configured to perform management of a lockdown of entity-related data in a database. For example, the machine identifies a replication lag trend associated with replicating data from a first data center to a second data center. The machine causes, based on the replication lag trend, a replication of data associated with a particular entity from a first record of the first data center to a second record of the second data center. The machine causes a lockdown, for a period of time, of the second record. The lockdown prevents servicing requests for data associated with the particular entity that are received from client devices associated with users related to the particular entity. The machine dynamically adjusts the period of time based on a monitoring of a completion of the replication. The machine causes a lifting of the lockdown based on the dynamically adjusted period of time.

### TECHNICAL FIELD

The present application relates generally to systems, methods, and computer program products for managing a lockdown of entity-related data in a database.

### BACKGROUND

Companies that provide content or services online may sometimes need to replicate data from one data center to another data center. A data center may be a group of networked computer servers typically used by organizations for storage, processing, or distribution of a large volume of data. The reasons for data replication may be many: load-balancing, system maintenance, re-direction of online traffic, etc. In order to maintain consistency of data, some systems lock down one or more databases while the data is being replicated from one data center to another data center.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 is a block diagram illustrating components of a lockdown management system, according to some example embodiments;

FIG. 3 is a flowchart illustrating a method for managing a lockdown of entity-related data in a database, according to some example embodiments;

FIG. 4 is a flowchart illustrating a method for managing a lockdown of entity-related data in a database, and representing additional steps of the method illustrated in FIG. 3, according to some example embodiments;

FIG. 5 is a flowchart illustrating a method for managing a lockdown of entity-related data in a database, and representing step 406 of the method illustrated in FIG. 4 in more detail, according to some example embodiments;

FIG. 6 is a flowchart illustrating a method for managing a lockdown of entity-related data in a database, and representing steps 302 and 304 of the method illustrated in FIG. 3 in more detail, according to some example embodiments;

FIG. 7 is a flowchart illustrating a method for managing a lockdown of entity-related data in a database, and representing step 308 of the method illustrated in FIG. 3 in more detail, according to some example embodiments;

FIG. 8 is a block diagram illustrating a mobile device, according to some example embodiments; and

FIG. 9 is a block diagram illustrating components of a machine, according to some example embodiments, able to read instructions from a machine-readable medium and perform any one or more of the methodologies discussed herein.

### DETAILED DESCRIPTION

Example methods and systems for managing a lockdown of entity-related data in a database, are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Often, companies that provide online content or services employ a distributed system that serves data from different data centers. Traditionally, a distributed system that serves data from different data centers routes online traffic according to a user identifier (e.g., a user ID) associated with a user requesting access to certain data. For example, a user of a consumer-facing website, such as a LinkedIn® login page, facilitates the logging in of the user based on the user's login credentials. The user may be a member of the professional online social network service (SNS) provided by LinkedIn®. A backend system may determine, based on the user's login credentials, that the user's request to access his profile page should be redirected to a particular data center (e.g., a London, UK data center, or a San Jose, Calif. data center).

A company, such as LinkedIn®, in addition to having members of the SNS as customers, may also have enterprise customers, such as various organizations or companies, to which it provides professional services. Examples of such professional services are recruiter services, sales services, advertising services, educational services, etc.

In some example embodiments, the distributed system that serves data from different data centers routes online traffic based on an entity identifier (ID) rather than a user ID. An entity may include an account or a contract. An account may be an organization or a company, or several organizations or companies grouped together (e.g., a parent company and a subsidiary company). Examples of an account may be “Google,” “Alphabet” (e.g., the parent company of Google), or “YouTube” (e.g., a subsidiary of Google). A contract may represent a particular agreement between the service-delivering company and an account that specifies a particular service to be delivered, or particular terms of agreement. In some instances, an account may be associated with several contracts.

According to various example embodiments, a computer system may issue a temporary lockdown of certain data records at a database of a data center in order to prevent users associated with an entity (e.g., Google, Microsoft®, etc.) from accessing or modifying the certain data records while the certain data records are being replicated (e.g., moved, transferred, copied, etc.) from a first data center to a second data center. In some instances, the users may be prevented from accessing data that is associated with the entity and with a service during a data replication process that occurs between two data centers. An example benefit of the lockdown is protecting the integrity and consistency of the data being replicated, across data centers. The data lockdown may include preventing “write” operations on the certain data, “read” operations on the certain data, preventing downloads of the certain data, uploads of the certain data, etc., or a suitable combination thereof.

For example, a user of LinkedIn® is employed by Google as a recruiter. Google may be an enterprise client of LinkedIn®, and as such may be identified as an “entity” by a computer system associated with LinkedIn®. The user may login into LinkedIn®, and may request access to a Recruiter service (e.g., a Recruiter application) provided by to LinkedIn® to Google based on a contract between LinkedIn® and Google. If the data associated with the entity (e.g., Google) and with the service (e.g., e.g., Recruiter service) is being replicated from a first data center to a second data center, a lockdown may be issued for the users associated with the entity who are requesting access to the service, and the user may be precluded from accessing the data associated with the entity and the service based on the issued lockdown. After a period of time, the lockdown may be lifted, and the data access request of the user may be serviced, by the system, by allowing the user to access the data associated with the entity and the service.

According to some example embodiments, the determination whether a user associated with an entity is precluded from accessing a service is based on the type of service the user attempts to access. For example, if the Google recruiter, in the example above, is attempting to use a payment service, the system does not lock down the data associated with Google and with the payment service. The Google recruiter may be allowed to continue to use the payment service.

In certain example embodiments, the data associated with an entity is served out of one data center. The lockdown may be issued based on a redirection of online traffic associated with a particular entity (or with a particular entity and a particular service) to a particular data center. For example, the system determines that a large number (e.g., a majority) of requests for data associated with an entity (or with an entity and a service) are received from a certain geographic area (e.g., from Europe). Based on the origin of the data access requests associated with the entity (or with the entity and service), a particular data center may be designated as the location from which to service the data access requests associated with the entity (or with the entity and service). In this example, a data center on the East Coast of the U.S. is designated to service the requests for data associated with the entity (or with the entity and service) based on the fact that the large number of data access requests associated with the entity (or with the entity and service) are received from Europe.

The designation of a particular data center as being the location from which to service requests for data associated with the entity (or with the entity and the service) may be made in a record of a database that pertains to managing access to the data associated with the entity (or with the entity and the service). The database record is associated with the entity. The database record may include a data center identifier of the second data center designated as the location from which to serve requests for data associated with the entity (or with the entity and the service), and an effective time representing a time to start servicing the requests for data associated with the entity (or with the entity and the service). The system may access the database record to determine to which data center to redirect a data access request associated with the entity.

In some instances, the effective time also indicates a time when a lockdown on the data associated with the entity (or with the entity and the service) is lifted. In various example embodiments, a progress of the data replication is being monitored (e.g., by a service) to determine whether the data replication is complete, and the effective time is dynamically adjusted based on the data replication being completed. In some instances, the effective time may be dynamically adjusted from a pre-determined (e.g., default) period of time to an actual current time corresponding to the time when the data replication is completed, or to the time the completion of the data replication is identified. An example benefit of such adaptive partial database lockdowns are shorter service disruptions and database downtimes.

According to various example embodiments, before a lockdown is issued and a data replication is started from a first data center to a second data center, the system determines a replication lag trend associated with replicating data from the first data center to the second data center. In some instances, the replication lag trend is determined, by a replication delay service, based on monitoring replication times from the first data center to the second data center during a recent time period (e.g., real-time, the last 30 min, etc.). In some instances, the replication lag trend from the first data center to the second data center is determined based on historical data pertaining to replication times that happened in the past at a similar time of day.

If the system determines that the replication lag is trending high for replications from the first data center to the second data center, the system may not initiate a data replication process from the first data center to the second data center for the data associated with the entity (or with the entity and the service) at that time. At a later time, the system may reiterate through the process of determining a further replication lag trend and of determining whether the system could initiate the data replication at the later time based on the further replication lag trend.

In some example embodiments, a lockdown management system for managing a lockdown of entity-related data in a database identifies a replication lag trend associated with replicating data from a first data center to a second data center. The lockdown management system causes, based on the replication lag trend, a replication of data associated with a particular entity from a first record of the first data center to a second record of the second data center. The lockdown management system causes a lockdown, for a period of time, of the second record of the second data center. The lockdown prevents servicing data access requests for data associated with the particular entity that are received from client devices associated with users related to the particular entity. The lockdown management system dynamically adjusts the period of time based on a monitoring of a completion of the replication of the data associated with the particular entity at the second record of the second data center. The lockdown management system causes a lifting of the lockdown based on the dynamically adjusted period of time.

In various example embodiments, the system receives a request for data associated with the entity and a service. The request is received from a client device associated with an entity-related user. The system identifies, based on the request, the second data center as a location from which to service the request for data associated with the entity and the service. The system determines that the data associated with the entity and the service is temporarily inaccessible at the second data center based on identifying the lockdown. The system cause a display, in a user interface of the client device, of a notification pertaining to a temporary inaccessibility of the data associated with the entity and the service.

According to some example embodiments, a database record associated with an entity ID is used by the lockdown management system to determine whether it can serve the data requests associated with the entity at a current time, and from which data center. For example, a database record associated with an entity ID (e.g., Entity 1234) includes a first entry that states: “For Entity 1234, serve all data request from the Oregon data center, starting at Oct. 1, 2016, 10:00 am.” “Entity 1234” may represent an account, a contract, etc. The first entry indicates the original datacenter Oregon data center) from which data requests for this entity are serviced.

The database record associated with the entity ID may include a second entry that designates a different data center (e.g., a Virginia data center) to service data requested for this entity. A second data center may be designated as a location from which to service the data requests for the entity for various reasons, such as, the first data center is overloaded, to speed up the servicing of the data requests, the second data center is geographically closer to the origin of the data requests, the first data center is undergoing maintenance, etc.

The second entry of the record may state that the requests for the data pertaining to Entity 1234, will be redirected to (e.g., serviced from) the Virginia data center, starting on Oct. 20, 2016, at “2:00 pm+10 min.” The time “2:00 pm+10 min” may indicate the effective time at which to start servicing data requests from the Virginia data center. The time “2:00 pm” may indicate the start time of the data replication of the entry-related data from the Oregon data center to the Virginia data center. If a data request comes in at 2:01 pm (e.g., the current time), the system reads this record, compares the current time with the effective time, and determines that the “current time” (e.g., 2:01 pm) is not the same as the “effective time” (e.g., 2:10 pm), and denies the data request.

To continue the example above, the period of time “10 min” may be a default period of time selected for a lockdown to safely replicate all the data related to the Entity 1234 from a first data center to a second data center. This default period of time may be longer than the actual time a lockdown would take.

in some example embodiments, an adaptive lockdown may be used in order to minimize system disruptions due to the lockdowns of entity-related records in databases. By utilizing an adaptive lockdown approach, the lockdown management system may dynamically adjust the default period of time to a shorter period of time based on real-time data pertaining to the durations of one or more replications of data from the first data center to the second data center.

A replication delay service may monitor, in real time, the replications between various data centers (e.g., from the first data center to the second data center). For example, the replication delay service determines that, at the current time, the duration of a replication (also “replication delay”)) from the Oregon data center to the Virginia data center is 30 sec., the replication delay from the Virginia data center to the Oregon data center is 60 sec., and the replication delay from the Oregon data center to a Texas data center is 45 sec. As data is replicated among data centers, the replication delay service keeps track of the durations of various replications among the data centers. This forms a history of data replications (e.g., replication delays at various times of day). For example, the replication delay service determines that at 2:00 pm, it takes at most 50 sec. for all the write requests that are happening at a first data center before 2:00 pm to be replicated to a particular second data center.

In some example embodiments, before the lockdown management system locks down the data related to the particular entity in a data center, instead of assigning the default time period (e.g., 10 min) to the lockdown, the lockdown management system assigns the real replication delay time as the value corresponding to the lockdown time in the record associated with the particular entity.

For example, the lockdown management system determines that the replication is scheduled for 2:00 pm. The lockdown management system determines that, on the particular day (e.g., the particular day of the week) at 2:00 pm, the historical replication delay is 30 sec. The lockdown management system assigns “30 sec.” to the value representing the duration of the replication, such that the database record states “2 pm+30 sec.”

In certain example embodiments, the lockdown management system queries the replication delay service with respect to whether the lockdown management system may start servicing data access requests for data associated with the entity. For example, between 2:00 pm and 2:02:15 pm, a lockdown is issued for a data center. After a data replication starts, the lockdown management system may generate queries that regard the completion of the replication and that are directed to the replication delay service at certain intervals of time. At 2:01 pm, the lockdown management system queries the replication delay service regarding a completion of the replication of the data pertaining to the entity. If the replication is not complete, the replication delay service will reply to the query and indicate in the query reply that the replication is not yet complete. At 2:02 pm and/or at 2:03 pm, the lockdown management system may generate other queries directed to the replication delay service. When the replication is completed, and the query reply indicates that the replication is completed, the lockdown management system updates the database record associated with the entry to indicate that the effective time corresponds to the current time (e.g., the time when the query reply is received by the lockdown management). This indicates that the lockdown is lifted, and that the data requests may be serviced from the respective data center for the particular entity.

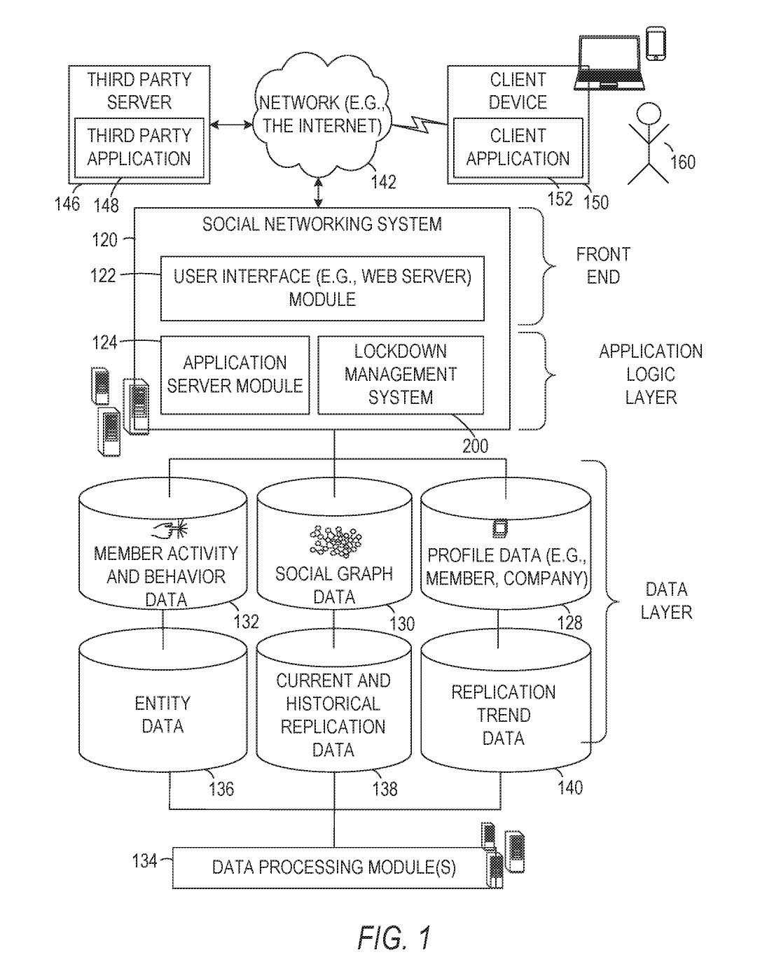

An example method and system for managing a lockdown of entity-related data in a database may be implemented in the context of the client-server system illustrated in FIG. 1. As illustrated in FIG. 1, the lockdown management system 200 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 142 to exchange information with the social networking system 120. Each of the client devices 150 may comprise a computing device that includes at least a display and communication capabilities with the network 142 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the SNS may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server modules) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the data migration system 200, which is described in more detail below.

Further, as shown in FIG. 1, a data processing module 134 may be used with a variety of applications, services, and features of the social networking system 120. The data processing module 134 may periodically access one or more of the databases 128, 130, 132, 136, 138, or 140, process (e.g., execute batch process jobs to analyze or mine) profile data, social graph data, member activity and behavior data, entity data, current and historical replication data, or replication trend data, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

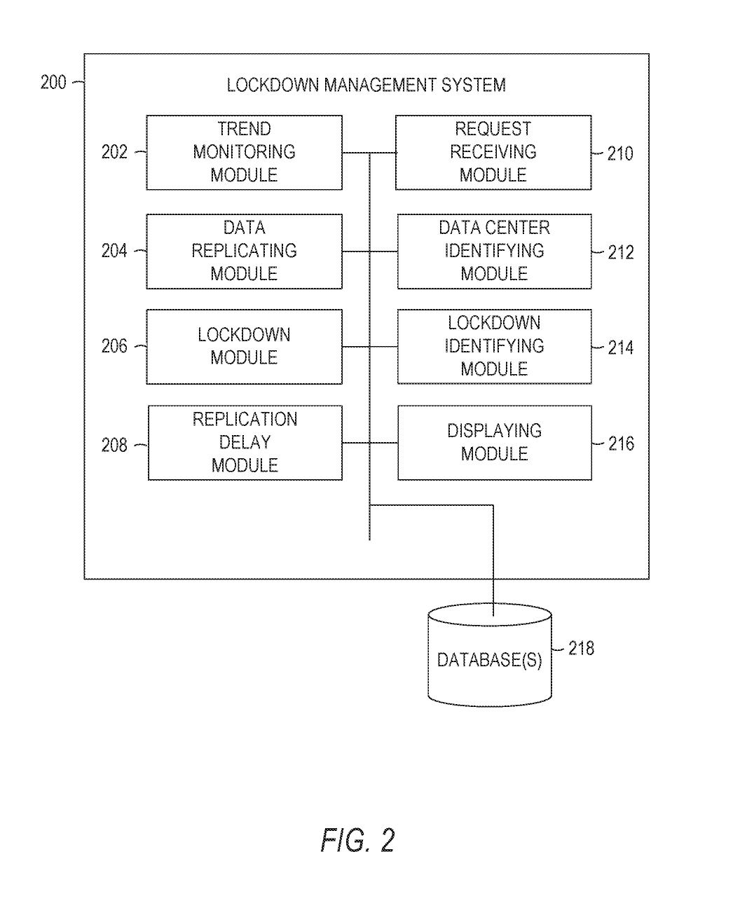

FIG. 2 is a block diagram illustrating components of the lockdown management system 200, according to some example embodiments. As shown in FIG. 2, the lockdown management system 200 includes a trend monitoring module 202, a data replicating module 204, a lockdown module 206, a replication delay module 208, a request receiving module 210, a data center identifying module 212, a lockdown identifying module 214, and a displaying module 216, all configured to communicate with each other (e.g., via a bus, shared memory, or a switch).

According to some example embodiments, the trend monitoring module 202 identifies a replication lag trend associated with replicating data from a first data center to a second data center. The trend monitoring module 202 may access data pertaining to the times associated with various replications of data from the first data center to the second data center, and, based on an analysis of the times, may determine whether the replication processes are slower, faster, or about the same over a period of time (e.g., 30 min).

In some example embodiments, the identifying of the replication lag trend, by the trend monitoring module 202, includes: identifying a plurality of timestamp pairs associated with data being replicated from the first data center to the second data center, each of the plurality of timestamp pairs identifying a begin-replication time and an end-replication time associated with a particular replication of data; determining a plurality of durations of a plurality of replications from the first data center to the second data center based on the plurality of timestamp pairs; and determining, based on the plurality of durations of the plurality of replications from the first data center to the second data center, that the plurality of replications are not trending high (e.g., trending low or flat) at a particular (e.g., current) time. A duration of a replication may be the time difference between an end-replication time and a begin-replication time. The plurality of replications may not be trending high (e.g., trending low or flat) when the plurality of durations of the plurality of replications from the first data center to the second data center indicate that the plurality of replications are happening faster or at constant speed (e.g., are not becoming slower).

In some example embodiments, the trend monitoring module 202 determines that the plurality of replications are trending high. Based on the determination that the plurality of replications are trending high, the trend monitoring module 202 determines that the replication of the data pertaining to the entity should not be performed at the particular time. The plurality of replications may be trending high when the plurality of durations of the plurality of replications indicate a slowing down of the plurality of replications.

The data replicating module 204 causes a replication of data associated with a particular entity from a first record of the first data center to a second record of the second data center. The causing of the replication of the data may be based on the replication lag trend. In some example embodiments, the causing of the replication of data based on the replication lag trend includes issuing a command to start replicating the data associated with the particular entity from a first record at the first data center to a second record at the second data center.

The lockdown module 206 causes a lockdown, for a period of time, of the second record of the second data center. The lockdown prevents servicing data access requests for data associated with the particular entity that are received from client devices associated with users related to the particular entity.

The lockdown module 206 dynamically adjusts the period of time based on a monitoring of a completion of the replication of the data associated with the particular entity at the second record of the second data center. The lockdown module 206 causes a lifting of the lockdown based on the dynamically adjusted period of time.

The replication delay module 208 monitors the completion of the replication of the data from the first record of the first data center to the second record of the second data center. The replication delay module 208, in some instances, is a service that tracks whether certain records have completed replicating between two data centers.

In some example embodiments, the lockdown module 206 queries a replication delay service (e.g., the replication delay module 208) that monitors the completion of the replication of the data associated with the particular entity at the second record of the second data center. The lockdown module 206 may receive a query reply (e.g., from the replication delay service) based on the querying of the replication delay service. The query reply may include data pertaining to a status of the replication of the data. The lockdown module 206 may modify an effective time in a record of a database that indicates a lockdown lifting time based on the data pertaining to the status of the replication of the data included in the query reply. The lockdown module 206 may lift the lockdown at the effective time. Also, at the effective time, the lockdown management system 200 may start allowing the servicing of the data requests for access to the data pertaining to the entity at the second data center.

The request receiving module 210 receives a request for data access to data associated with the entity. The request is received from a client device associated with an entity-related user (e.g., a user associated with an entity, such as an account or contract).

The data center identifying module 212 identifies, based on the request for data access to data associated with the entity, the second data center as a location from which to service the request for data access to the data associated with the entity. For instance, the data center identifying module 212 may access, based on an entity identifier included in the request for data access, a database record that is associated with the entity and that includes an identifier of the second data center. The identifier of the second data center may indicate the location from which to service the requests for data access to the data associated with the entity.

The lockdown identifying module 214 determines that the data associated with the entity is temporarily inaccessible at the second data center based on identifying the lockdown. According to some example embodiments, the determining that the data associated with the entity is temporarily inaccessible at the second data center includes: accessing a database record pertaining to managing access to the data associated with the entity, the database record including a data center identifier of the second data center designated as the location from which to service requests for data associated with the entity, and an effective time representing a time to start servicing the requests for data associated with the entity; determining a current time; comparing the current time and the effective time; and determining that the current time is different from the effective time.

The displaying module 216 causes a display, in a user interface of the client device, of a notification pertaining to a temporary inaccessibility of the data associated with the entity. The notification may state, for example, “The page requested is currently unavailable. Please try accessing the page again in 10 min.”

In some example embodiments, the request receiving module 210 receives a request for data access to data associated with the entity and a service. The request is received from a client device associated with an entity-related user. For example, a user, who is a recruiter at Google, attempts to access a web page pertaining to recruiting services for Google, wherein the web page is maintained by a third party (e.g., LinkedIn®) from a client device associated with the user.

The data center identifying module 212 identifies the second data center as a location from which to service the request for data access to the data associated with the entity and the service. The identifying may be based on the request for data access to data associated with the entity and the service. For instance, the data center identifying module 212 may access, based on an entity identifier included in the request for data access, a database record that is associated with the entity and the service, and that includes an identifier of the second data center. The identifier of the second data center may indicate the location from which to service the requests for data access to the data associated with the entity.

The lockdown identifying module 214 determines that the data associated with the entity and the service is temporarily inaccessible at the second data center based on identifying the lockdown. In various example embodiments, the determining that the data associated with the entity and the service is temporarily inaccessible at the second data center includes: accessing a database record pertaining to managing access to the data associated with the entity and the service, the database record including a data center identifier of the second data center designated as the location from which to service requests for data associated with the entity and the service, and an effective time representing a time to start servicing the requests for data associated with the entity and the service; determining a current time; comparing the current time and the effective time; and determining that the current time is different from the effective time.

The displaying module 216 causes a display, in a user interface of the client device, of a notification pertaining to a temporary inaccessibility of the data associated with the entity and the service.

To perform one or more of its functionalities, the lockdown management system 200 may communicate with one or more other systems. For example, an integration system may integrate the lockdown management system 200 with one or more email server(s), web server(s), one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 218 (e.g., database 128, 130, 132, 136, 138, or 140).

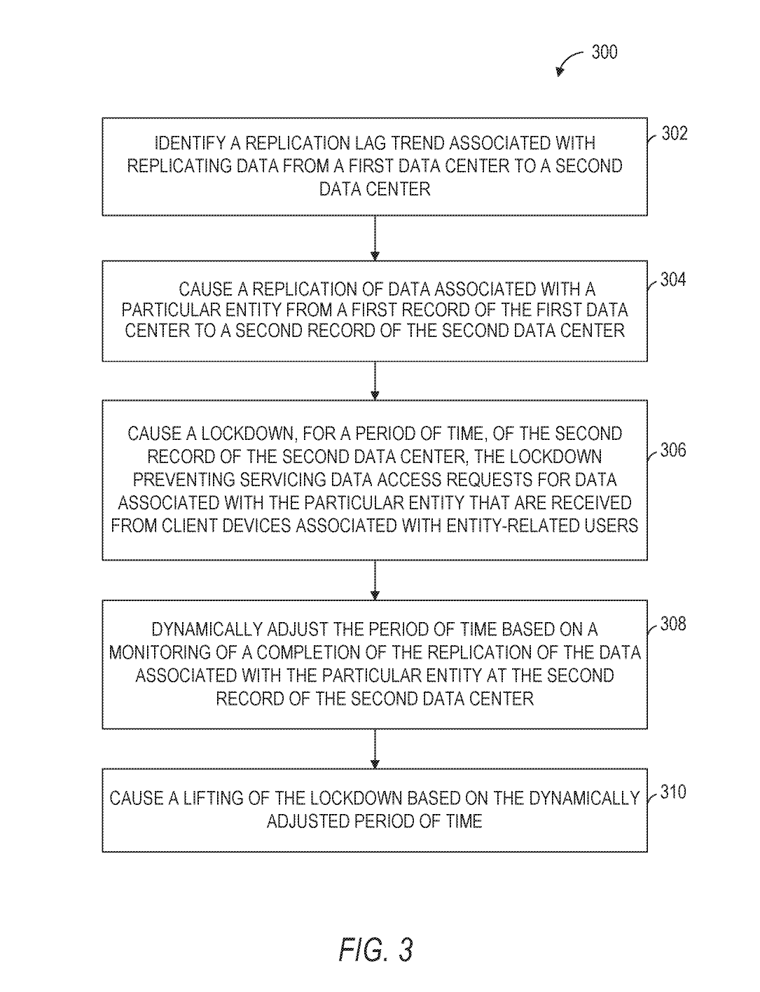

FIGS. 3-7 are flowcharts illustrating a method for managing a lockdown of entity-related data in a database, according to some example embodiments. Operations in the method 300 illustrated in FIG. 3 may be performed using modules described above with respect to FIG. 2. As shown in FIG. 3, method 300 may include one or more of method operations 302, 304, 306, 308, and 310, according to some example embodiments.

At operation 302, the trend monitoring module 202 identifies a replication lag trend associated with replicating data from a first data center to a second data center.

At operation 304, the data replicating module 204 causes a replication of data associated with a particular entity from a first record of the first data center to a second record of the second data center. The causing of the replication of the data associated with the particular entity from the first record of the first data center to the second record of the second data center may be based on the replication lag trend.

At operation 306, the lockdown module 206 causes a lockdown, for a period of time, of the second record of the second data center. The lockdown prevents servicing data access requests for data associated with the particular entity that are received from client devices associated with users related to the particular entity.

At operation 308, the lockdown module 206 dynamically adjusts the period of time based on a monitoring of a completion of the replication of the data associated with the particular entity at the second record of the second data center.

At operation 310, the lockdown module 206 causes a lifting of the lockdown based on the dynamically adjusted period of time.

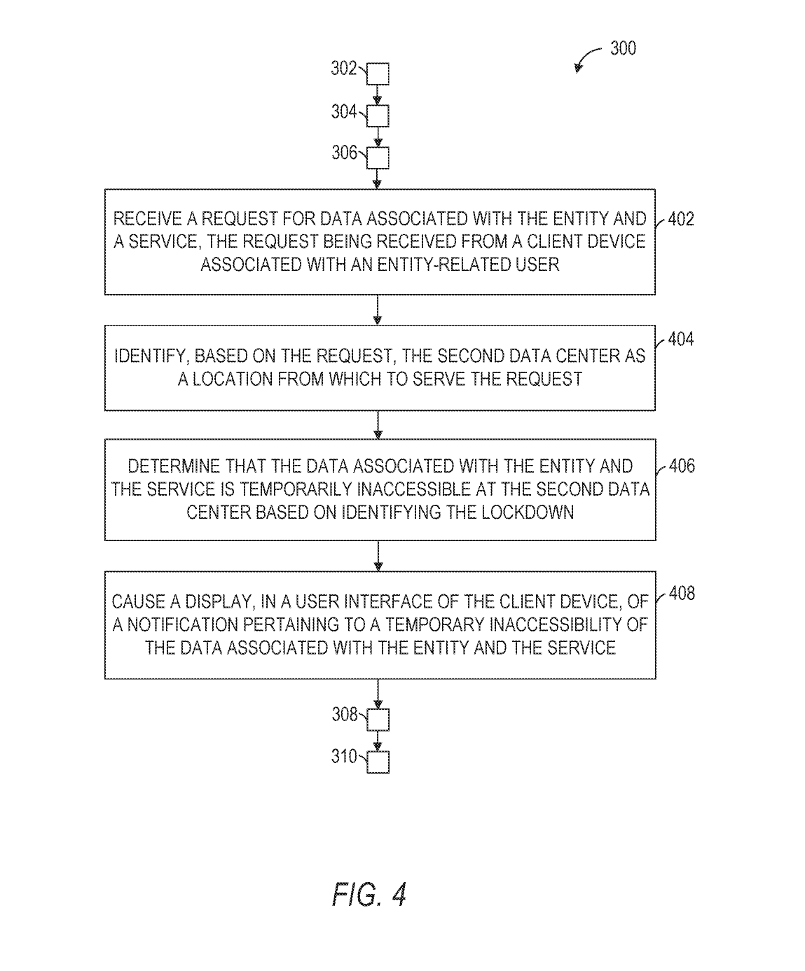

Further details with respect to the method operations of the method 300 are described below with respect to FIGS. 4-7.

As shown in FIG. 4, the method 300 may include one or more method operations 402, 404, 406, or 408, according to some example embodiments. Operation 402 may be performed after operation 306, in which the lockdown module 206 causes a lockdown, for a period of time, of the second record of the second data center.

At operation 402, the request receiving module 210 receives a request for data associated with the entity and a service. The request may be received from a client device associated with an entity-related user.

At operation 404, the data center identifying module 212 identifies the second data center as a location from which to service the request for data associated with the entity and the service. The identifying of the second data center as the location from which to service the request for data may be based on the request. For instance, the data center identifying module 212 may access, based on an entity identifier included in the request for data access, a database record that is associated with the entity and the service, and that includes an identifier of the second data center. The identifier of the second data center may indicate the location from which to service the requests for data access to the data associated with the entity.

At operation 406, the lockdown identifying module 214 determines that the data associated with the entity and the service is temporarily inaccessible at the second data center based on identifying the lockdown.

At operation 404, the displaying module 216 causes a display, in a user interface of the client device, of a notification pertaining to a temporary inaccessibility of the data associated with the entity and the service.

In some example embodiments, the request receiving module 210 receives a request for data associated with the entity. The request may be received from a client device associated with an entity-related user. The data center identifying module 212 identifies the second data center as a location from which to service the request for data associated with the entity. The identifying of the second data center as the location from which to service the request for data may be based on the request. For instance, the data center identifying module 212 may access, based on an entity identifier included in the request for data access, a database record that is associated with the entity and that includes an identifier of the second data center. The identifier of the second data center may indicate the location from which to service the requests for data access to the data associated with the entity. The lockdown identifying module 214 determines that the data associated with the entity is temporarily inaccessible at the second data center based on identifying the lockdown. The displaying module 216 causes a display, in a user interface of the client device, of a notification pertaining to a temporary inaccessibility of the data associated with the entity.

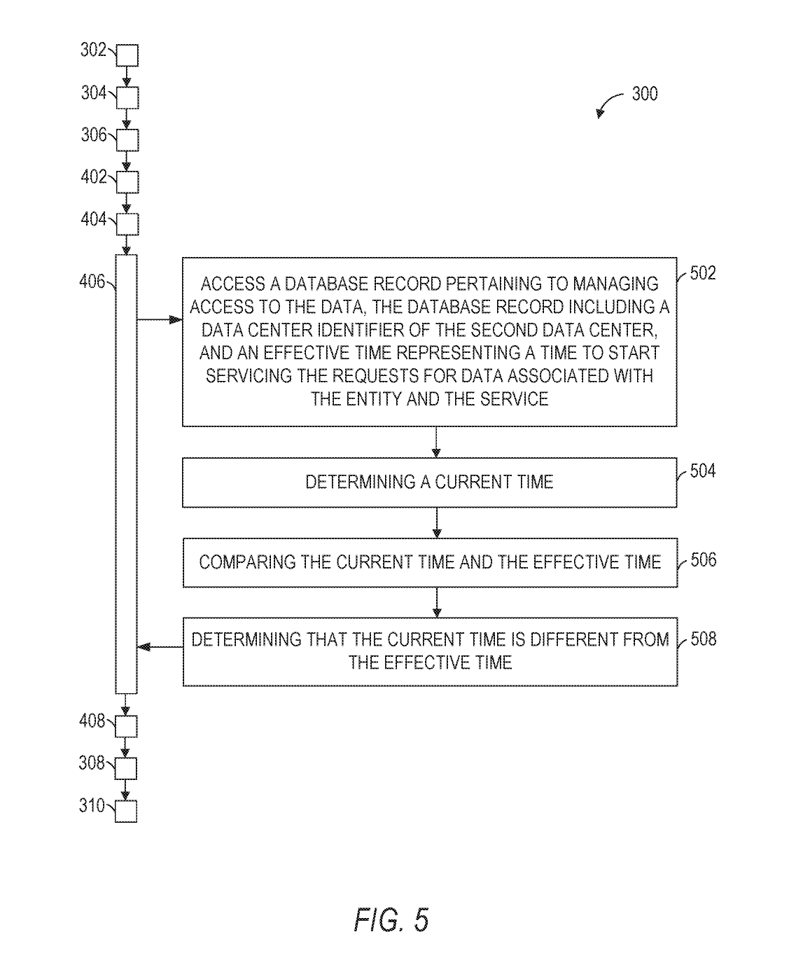

As shown in FIG. 5, the method 300 may include one or more method operations 502, 504, 506, or 508, according to some example embodiments. Operation 502 may be performed as part (e.g., a precursor task, a subroutine, or a portion) of operation 406 of FIG. 4, in which the lockdown identifying module 214 determines that the data associated with the entity and the service is temporarily inaccessible at the second data center based on identifying the lockdown.

At operation 502, the lockdown identifying module 214 accesses a database record pertaining to managing access to the data associated with the entity and the service. The database record includes a data center identifier of the second data center designated as the location from which to service requests for data associated with the entity and the service, and an effective time representing a time to start serving the requests for data associated with the entity and the service.

At operation 504, the lockdown identifying module 214 determines a current time. In some example embodiments, to determine the current time, the lockdown identifying module 214 queries the operating system. In response to the query, the operating system services the query and provides a query reply that includes the current time.

At operation 506, the lockdown identifying module 214 compares the current time and the effective time.

At operation 508, the lockdown identifying module 214 determines that the current time is different from the effective time.

In some example embodiments, the determining that the data associated with the entity is temporarily inaccessible at the second data center includes: accessing a database record pertaining to managing access to the data associated with the entity, the database record including a data center identifier of the second data center designated as the location from which to service requests for data associated with the entity, and an effective time representing a time to start servicing the requests for data associated with the entity; determining a current time; comparing the current time and the effective time; and determining that the current time is different from the effective time.

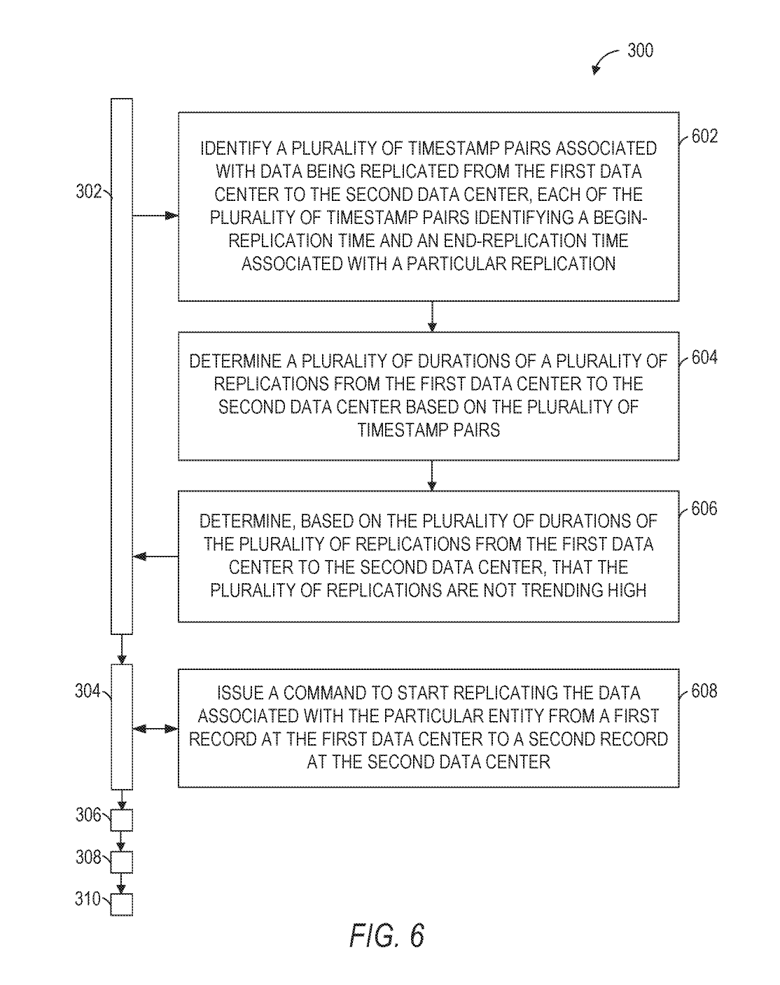

As shown in FIG. 6, the method 300 may include one or more method operations 602, 604, 606, or 608, according to some example embodiments. Operation 602 may be performed as part (e.g., a precursor task, a subroutine, or a portion) of operation 302 of FIG. 3, in which the trend monitoring module 202 identifies a replication lag trend associated with replicating data from a first data center to a second data center.

At operation 602, the trend monitoring module 202 identities a plurality of timestamp pairs associated with data being replicated from the first data center to the second data center. Each of the plurality of timestamp pairs identifies a begin-replication time and an end-replication time associated with a particular replication of data.

At operation 604, the trend monitoring module 202 determines a plurality of durations of a plurality of replications from the first data center to the second data center based on the plurality of timestamp pairs. A duration of a replication may be measure by the difference between a begin-replication time and an end-replication time.

At operation 606, the trend monitoring module 202 determines that the replication is not trending high. The determining that the replication is not trending high may be based on the plurality of durations of replications from the first data center to the second data center.

Operation 608 may be performed as part (e.g., a precursor task, a subroutine, or a portion) of operation 304 of FIG. 3, in which the data replicating module 204 causes a replication of data associated with a particular entity from a first record of the first data center to a second record of the second data center.

At operation 608, the data replicating module 204 issues a command to start replicating the data associated with the particular entity from a first record at the first data center to a second record at the second data center.

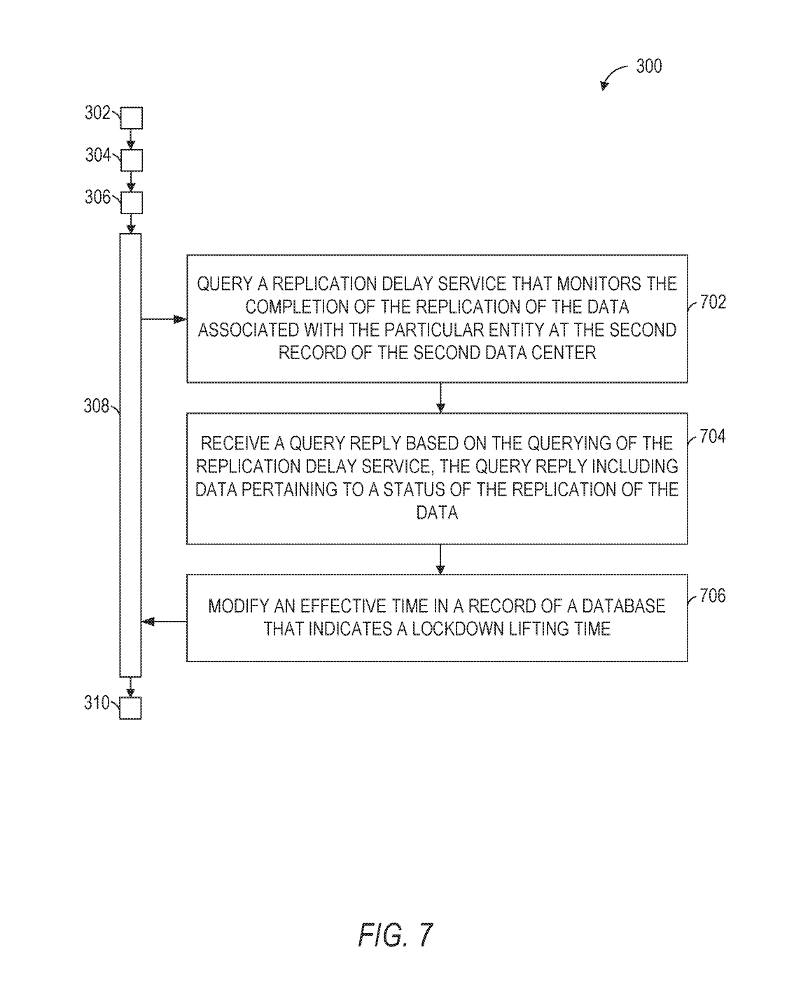

As shown in FIG. 7, the method 300 may include operations 702, 704, or 706, according to some example embodiments. Operation 702 may be performed as part (e.g., a precursor task, a subroutine, or a portion) of operation 308 of FIG. 3, in which the lockdown module 206 dynamically adjusts the period of time based on a monitoring of a completion of the replication of the data associated with the particular entity at the second record of the second data center.

At operation 702, the lockdown module 206 queries a replication delay service that monitors the completion of the replication of the data associated with the particular entity at the second record of the second data center.

At operation 704, the lockdown module 206 receives a query reply from the replication delay service based on the querying of the replication delay service. The query reply includes data pertaining to a status of the replication of the data.

At operation 706, the lockdown module 206 modifies (e.g., updates, changes, etc.) an effective time in a record of a database that indicates a lockdown lifting time. The modifying of the effective time may be based on the data pertaining to the status of the replication of the data included in the query reply.

### Example Mobile Device

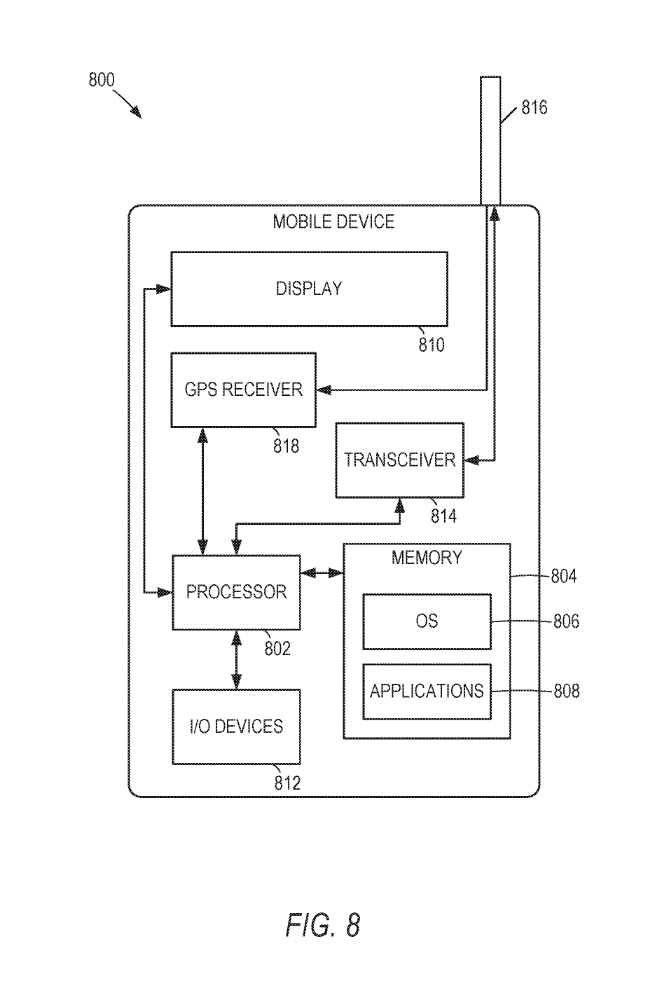

FIG. 8 is a block diagram illustrating a mobile device 800, according to an example embodiment. The mobile device 800 may include a processor 802. The processor 802 may be any of a variety of different types of commercially available processors 802 suitable for mobile devices 800 (for example, an XScale architecture microprocessor, a microprocessor without interlocked pipeline stages (MIPS) architecture processor, or another type of processor 802). A memory 804, such as a random access memory (RAM), a flash memory, or other type of memory, is typically accessible to the processor 802. The memory 804 may be adapted to store an operating system (OS) 806, as well as application programs 808, such as a mobile location enabled application that may provide LBSs to a user. The processor 802 may be coupled, either directly or via appropriate intermediary hardware, to a display 810 and to one or more input/output (I/O) devices 812, such as a keypad, a touch panel sensor, a microphone, and the like. Similarly, in some embodiments, the processor 802 may be coupled to a transceiver 814 that interfaces with an antenna 816. The transceiver 814 may be configured to both transmit and receive cellular network signals, wireless data signals, or other types of signals via the antenna 816, depending on the nature of the mobile device 800. Further, in some configurations, a GPS receiver 818 may also make use of the antenna 816 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

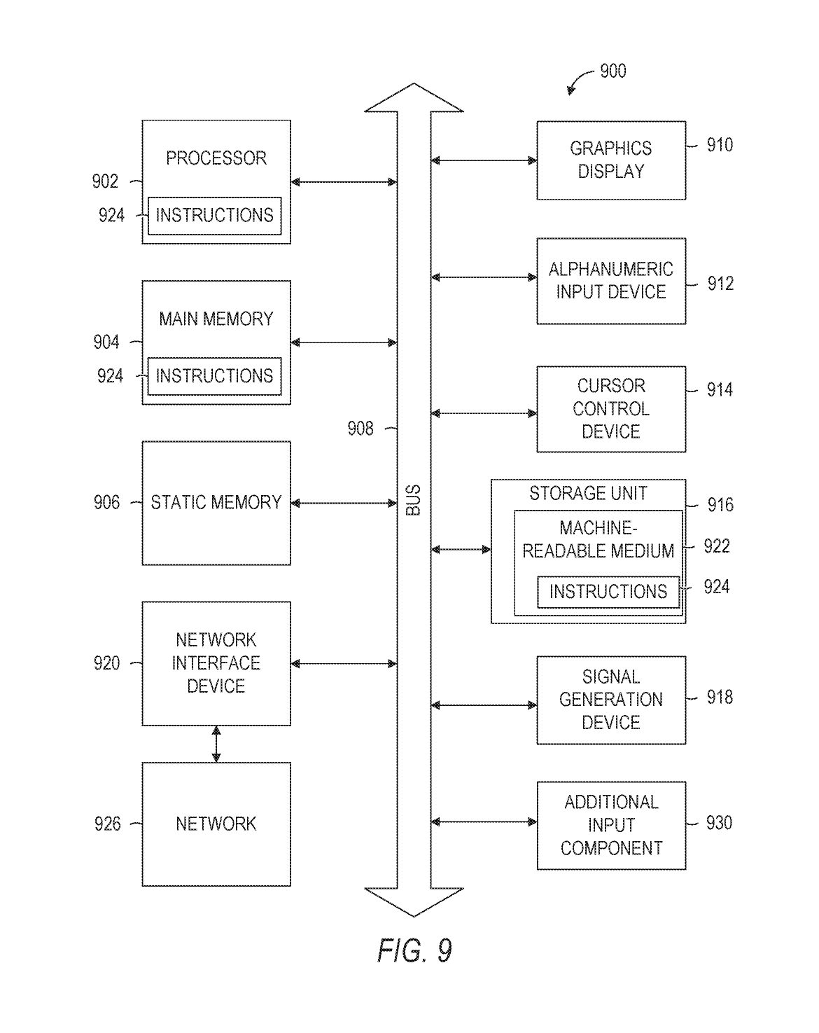

FIG. 9 is a block diagram illustrating components of a machine 900, according to some example embodiments, able to read instructions 924 from a machine-readable medium 922 (e.g., a non-transitory machine-readable medium, a machine-readable storage medium, a computer-readable storage medium, or any suitable combination thereof) and perform any one or more of the methodologies discussed herein, in whole or in part. Specifically, FIG. 9 shows the machine 900 in the example form of a computer system (e.g., a computer) within which the instructions 924 (e.g., software, a program, an application, an applet, an app, or other executable code) for causing the machine 900 to perform any one or more of the methodologies discussed herein may be executed, in whole or in part.

In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include any collection of machines that individually or jointly execute the instructions 924 to perform all or part of any one or more of the methodologies discussed herein,

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more modules (e.g., software modules) described herein.

The machine 900 may further include a graphics display 910 (e.g., a plasma display panel (PDP), a light emitting diode (LED) display, a liquid crystal display (LCD), a projector, a cathode ray tube (CRT), or any other display capable of displaying graphics or video). The machine 900 may also include an alphanumeric input device 912 (e.g., a keyboard or keypad), a cursor control device 914 (e.g., a mouse, a touchpad, a trackball, a joystick, a motion sensor, an eye tracking device, or other pointing instrument), a storage unit 916, an audio generation device 918 (e.g., a sound card, an amplifier, a speaker, a headphone jack, or any suitable combination thereof), and a network interface device 920.

The storage unit 916 includes the machine-readable medium 922 (e.g., a tangible and non-transitory machine-readable storage medium) on which are stored the instructions 924 embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered machine-readable media (e.g., tangible and non-transitory machine-readable media). The instructions 924 may be transmitted or received over the network 926 via the network interface device 920. For example, the network interface device 920 may communicate the instructions 924 using any one or more transfer protocols (e.g., hypertext transfer protocol (HTTP)).

In some example embodiments, the machine 900 may be a portable computing device, such as a smart phone or tablet computer, and have one or more additional input components 930 (e.g., sensors or gauges). Examples of such input components 930 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 924 for execution by the machine 900, such that the instructions 924, when executed by one or more processors of the machine 900 (e.g., processor 902), cause the machine 900 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module ay be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
identifying a replication lag trend associated with replicating data from a first data center to a second data center;
causing, based on the replication lag trend, a replication of data associated with a particular entity from a first record of the first data center to a second record of the second data center:
using one or more hardware processors, causing a lockdown, for a period of time, of the second record of the second data center, the lockdown preventing servicing data access requests for data associated with the particular entity that are received from client devices associated with users related to the particular entity;
dynamically adjusting the period of time based on a monitoring of a completion of the replication of the data associated with the particular entity at the second record of the second data center; and
causing a lifting of the lockdown based on the dynamically adjusted period of time.

2. The method of claim 1, further comprising:
receiving a request for data associated with the entity and a service, the request being received from a client device associated with an entity-related user;
identifying, based on the request, the second data center as a location from which to service the request for data associated with the entity and the service;
determining that the data associated with the entity and the service is temporarily inaccessible at the second data center based on identifying the lockdown; and
causing a display, in a user interface of the client device, of a notification pertaining to a temporary inaccessibility of the data associated with the entity and the service.

3. The method of claim 2, wherein the determining that the data associated with the entity and the service is temporarily inaccessible at the second data center includes:
accessing a database record pertaining to managing access to the data associated with the entity and the service, the database record including a data center identifier of the second data center designated as the location from which to service requests for data associated with the entity and the service, and an effective time representing a time to start servicing the requests for data associated with the entity and the service;
determining a current time;
comparing the current time and the effective time; and
determining that the current time is different from the effective time.

4. The method of claim 1, further comprising:
receiving a request for data associated with the entity, the request being received from a client device associated with an entity-related user;
identifying, based on the request, the second data center as a location from which to service the request for data associated with the entity;
determining that the data associated with the entity is temporarily inaccessible at the second data center based on identifying the lockdown; and
causing a display, in a user interface of the client device, of a notification pertaining to a temporary inaccessibility of the data associated with the entity.

5. The method of claim 4, wherein the determining that the data associated with the entity is temporarily inaccessible at the second data center includes:
accessing a database record pertaining to managing access to the data associated with the entity, the database record including a data center identifier of the second data center designated as the location from which to service requests for data associated with the entity, and an effective time representing a time to start servicing the requests for data associated with the entity;
determining a current time;
comparing the current time and the effective time; and
determining that the current time is different from the effective time.

6. The method of claim 1, wherein the identifying of the replication lag trend includes:
identifying a plurality of timestamp pairs associated with data being replicated from the first data center to the second data center, each of the plurality of timestamp pairs identifying a begin-replication time and an end-replication time associated with a particular replication of data;
determining a plurality of durations of a plurality of replications from the first data center to the second data center based on the plurality of timestamp pairs; and
determining, based on the plurality of durations of the plurality of replications from the first data center to the second data center, that the plurality of replications are not trending high, and
wherein the causing of the replication of data based on the replication lag trend includes:
issuing a command to start replicating the data associated with the particular entity from a first record at the first data center to a second record at the second data center.

7. The method of claim 1, wherein the dynamically adjusting the period of time includes:
querying a replication delay service that monitors the completion of the replication of the data associated with the particular entity at the second record of the second data center;
receiving a query reply based on the querying of the replication delay service, the query reply including data pertaining to a status of the replication of the data; and
modifying an effective time in a record of a database that indicates a lockdown lifting time based on the data pertaining to the status of the replication of the data.

8. A system comprising:
one or more hardware processors; and
a machine-readable medium for storing instructions that, when executed by the one or more hardware processors, cause the one or more hardware processors to perform operations comprising:
identifying a replication lag trend associated with replicating data from a first data center to a second data center;
causing, based on the replication lag trend, a replication of data associated with a particular entity from a first record of the first data center to a second record of the second data center;
causing a lockdown, for a period of time, of the second record of the second data center, the lockdown preventing servicing data access requests for data associated with the particular entity that are received from client devices associated with users related to the particular entity;
dynamically adjusting the period of time based on a monitoring of a completion of the replication of the data associated with the particular entity at the second record of the second data center; and
causing a lifting of the lockdown based on the dynamically adjusted period of time.

9. The system of claim 8, wherein the operations further comprise:
receiving a request for data associated with the entity and a service, the request being received from a client device associated with an entity-related user;
identifying, based on the request, the second data center as a location from which to service the request for data associated with the entity and the service;
determining that the data associated with the entity and the service is temporarily inaccessible at the second data center based on identifying the lockdown; and
causing a display, in a user interface of the client device, of a notification pertaining to a temporary inaccessibility of the data associated with the entity and the service.

10. The system of claim 9, wherein the determining that the data associated with the entity and the service is temporarily inaccessible at the second data center includes:
accessing a database record pertaining to managing access to the data associated with the entity and the service, the database record including a data center identifier of the second data center designated as the location from which to service requests for data associated with the entity and the service, and an effective time representing a time to start servicing the requests for data associated with the entity and the service;
determining a current time;
comparing the current time and the effective time; and
determining that the current time is different from the effective time.

11. The system of claim 8, wherein the operations further comprise:
receiving a request for data associated with the entity, the request being received from a client device associated with an entity-related user;
identifying, based on the request, the second data center as a location from which to service the request for data associated with the entity;
determining that the data associated with the entity is temporarily inaccessible at the second data center based on identifying the lockdown; and
causing a display, in a user interface of the client device, of a notification pertaining to a temporary inaccessibility of the data associated with the entity.

12. The system of claim 11, wherein the determining that the data associated with the entity is temporarily inaccessible at the second data center includes:
accessing a database record pertaining to managing access to the data associated with the entity, the database record including a data center identifier of the second data center designated as the location from which to service requests for data associated with the entity, and an effective time representing a time to start servicing the requests for data associated with the entity;
determining a current time;
comparing the current time and the effective time; and
determining that the current time is different from the effective time.

13. The system of claim 8, wherein the identifying of the replication lag trend includes:
identifying a plurality of timestamp pairs associated with data being replicated from the first data center to the second data center, each of the plurality of timestamp pairs identifying a begin-replication time and an end-replication time associated with a particular replication of data;
determining a plurality of durations of a plurality of replications from the first data center to the second data center based on the plurality of timestamp pairs; and
determining, based on the plurality of durations of the plurality of replications from the first data center to the second data center, that the plurality of replications are not trending high, and
wherein the causing of the replication of data based on the replication lag trend includes:
issuing a command to start replicating the data associated with the particular entity from a first record at the first data center to a second record at the second data center.

14. The system of claim 8, wherein the dynamically adjusting the period of time includes:
querying a replication delay service that monitors the completion of the replication of the data associated with the particular entity at the second record of the second data center;
receiving a query reply based on the querying of the replication delay service, the query reply including data pertaining to a status of the replication of the data; and
modifying an effective time in a record of a database that indicates a lockdown lifting time based on the data pertaining to the status of the replication of the data.

15. A non-transitory machine-readable storage medium comprising instructions that, when executed by one or more hardware processors of a machine, cause the one or more hardware processors to perform operations comprising:
identifying a replication lag trend associated with replicating data from a first data center to a second data center;
causing, based on the replication lag trend, a replication of data associated with a particular entity from a first record of the first data center to a second record of the second data center;
causing a lockdown, for a period of time, of the second record of the second data center, the lockdown preventing servicing data access requests for data associated with the particular entity that are received from client devices associated with users related to the particular entity;
dynamically adjusting the period of time based on a monitoring of a completion of the replication of the data associated with the particular entity at the second record of the second data center; and
causing a lifting of the lockdown based on the dynamically adjusted period of time.

16. The non-transitory machine-readable storage medium of claim 15, wherein the operations further comprise:
receiving a request for data associated with the entity and a service, the request being received from a client device associated with an entity-related user;
identifying, based on the request, the second data center as a location from which to service the request for data associated with the entity and the service;
determining that the data associated with the entity and the service is temporarily inaccessible at the second data center based on identifying the lockdown; and
causing a display, in a user interface of the client device, of a notification pertaining to a temporary inaccessibility of the data associated with the entity and the service.

17. The non-transitory machine-readable storage medium of claim 16, wherein the determining that the data associated with the entity and the service is temporarily inaccessible at the second data center includes:
accessing a database record pertaining to managing access to the data associated with the entity and the service, the database record including a data center identifier of the second data center designated as the location from which to service requests for data associated with the entity and the service, and an effective time representing a time to start servicing the requests for data associated with the entity and the service;
determining a current time;
comparing the current time and the effective time; and
determining that the current time is different from the effective time.

18. The non-transitory machine-readable storage medium of claim 15, wherein the operations further comprise:
receiving a request for data associated with the entity, the request being received from a client device associated with an entity-related user;
identifying, based on the request, the second data center as a location from which to service the request for data associated with the entity;
determining that the data associated with the entity is temporarily inaccessible at the second data center based on identifying the lockdown; and
causing a display, in a user interface of the client device, of a notification pertaining to a temporary inaccessibility of the data associated with the entity.

19. The non-transitory machine-readable storage medium of claim 18, wherein the determining that the data associated with the entity is temporarily inaccessible at the second data center includes:
accessing a database record pertaining to managing access to the data associated with the entity, the database record including a data center identifier of the second data center designated as the location from which to service requests for data associated with the entity, and an effective time representing a time to start servicing the requests for data associated with the entity;
determining a current time;
comparing the current time and the effective time; and
determining that the current time is different from the effective time.

20. The non-transitory machine-readable storage medium of claim 15, wherein the identifying of the replication lag trend includes:
identifying a plurality of timestamp pairs associated with data being replicated from the first data center to the second data center, each of the plurality of timestamp pairs identifying a begin-replication time and an end-replication time associated with a particular replication of data;
determining a plurality of durations of a plurality of replications from the first data center to the second data center based on the plurality of timestamp pairs; and
determining, based on the plurality of durations of the plurality of replications from the first data center to the second data center, that the plurality of replications are not trending high, and
wherein the causing of the replication of data based on the replication lag trend includes:
issuing a command to start replicating the data associated with the particular entity from a first record at the first data center to a second record at the second data center.
